(19) United States
(12) Patent Application Publication
(10) Pub. No.: US 2026/0136425 A1
(43) Pub. Date: May 14, 2026

(54) METHOD FOR DETERMINING RADIO LINK FAILURE, TERMINAL, AND CHIP

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN)

(73) Assignee: GUANGDONG OPPO MOBILE TELECOMMUNICATIONS CORP., LTD., Dongguan (CN)

(21) Appl. No.: 19/445,324

(22) Filed: Jan. 9, 2026

Related U.S. Application Data
(63) Continuation of application No. PCT/CN2023/111233, filed on Aug. 4, 2023.

(51) Int. Cl. H04W 76/18; H04W 72/25

(52) U.S. Cl. CPC H04W 76/18; H04W 72/25

(57) ABSTRACT

Provided is a radio link failure (RLF) determination method, which is applied to a first terminal. In the method, when a carrier RLF occurs in all carriers in a first carrier set, it is determined that a link RLF occurs in a sidelink between a first terminal and a second terminal, the first carrier set is used for sidelink transmission between the first terminal and the second terminal.

### CROSS REFERENCE TO RELATED APPLICATIONS

This is a continuation of International Application No. PCT/CN2023/111233 filed on Aug. 4, 2023, and entitled “METHOD AND APPARATUS FOR DETERMINING RADIO LINK FAILURE, TERMINAL, CHIP, AND STORAGE MEDIUM” , the disclosure of which is incorporated therein by reference in its entirety.

### TECHNICAL FIELD

Embodiments of the present disclosure relate to the field of communication technologies, and specifically to a method and apparatus for determining radio link failure, a terminal, a chip, and a storage medium.

### BACKGROUND

In the existing New Radio (NR) Sidelink (SL) system, a single-carrier-based Radio Link Failure (RLF) mechanism is designed. In a single-carrier system, if a transmitting terminal fails to receive a Physical Sidelink Feedback Channel (PSFCH) sent by a receiving terminal at a PSFCH reception timing, and the number of times for which such event occurs reaches a certain number, RLF is triggered.

However, at present, there is no solution about how to determine whether RLF occurs on a sidelink in a multi-carrier system.

### SUMMARY

According to a first aspect, an embodiment of the present disclosure provides a method for determining radio link failure, applied to a first terminal. The method includes: in a case that carrier radio link failure (RLF) occurs on all carriers in a first carrier set, determining that link RLF occurs on the sidelink between the first terminal and a second terminal. Here, the first carrier set is used for sidelink transmission between the first terminal and the second terminal.

According to a second aspect, an embodiment of the present disclosure provides a terminal, including a processor and a memory. The memory is configured to store a computer program, and the processor is configured to call and execute the computer program stored in the memory to perform the aforementioned method for determining radio link failure.

According to a fourth aspect, an embodiment of the present disclosure provides a chip, configured to implement the aforementioned method for determining radio link failure. Specifically, the chip includes: a processor, configured to call and execute a computer program from a memory, so that a device installed with the chip performs the aforementioned method for determining radio link failure.

### BRIEF DESCRIPTION OF THE DRAWINGS

The accompanying drawings described herein are intended to provide a further understanding of the present disclosure, and constitute a part of the present disclosure, and the schematic embodiments of the present disclosure and the description thereof are intended to explain the present disclosure, and do not constitute an undue limitation of the present disclosure. In the drawings:

FIG. 1 is a schematic diagram of resource selection corresponding to Mode A according to an embodiment of the present disclosure.

FIG. 2 is a schematic diagram of resource selection corresponding to Mode B according to an embodiment of the present disclosure.

FIG. 3 is a schematic flowchart of a method for determining radio link failure according to an embodiment of the present disclosure.

FIG. 4 is a schematic structural diagram of an apparatus for determining radio link failure according to an embodiment of the present disclosure.

FIG. 5 is a schematic structural diagram of a communication device according to an embodiment of the present disclosure.

FIG. 6 is a schematic structural diagram of a chip according to an embodiment of the present disclosure.

### DETAILED DESCRIPTION

Hereinafter, the technical solutions in the embodiments of the present disclosure will be described with reference to the accompanying drawings in the embodiments of the present disclosure, and it is apparent that the described embodiments are part of the embodiments of the present disclosure, but not all the embodiments. Based on the embodiments in the present disclosure, all other embodiments obtained by those skilled in the art without creative work fall within the scope of protection of the present disclosure.

The technical solutions of the embodiments of the present disclosure can be applied to various sidelink communication systems. To facilitate understanding of the technical solutions of the embodiments of the present disclosure, the related technologies involved in the embodiments of the present disclosure are described below. The following related technologies can be combined with the technical solutions of the embodiments of the present disclosure in any way, and all such combinations fall within the protection scope of the embodiments of the present disclosure.

### 1. Device-To-Device (D2D)/Vehicle-To-Everything (V2X) in Long Term Evolution (LTE)

Device-to-device communication is a D2D-based SL transmission technology. Unlike the traditional communication mode in cellular systems where data is received or transmitted through a base station, the V2X system adopts a terminal-to-terminal direct communication mode, thus achieving higher spectrum efficiency and lower transmission latency. The 3rd Generation Partnership Project (3GPP) defines two transmission modes: Mode A and Mode B.

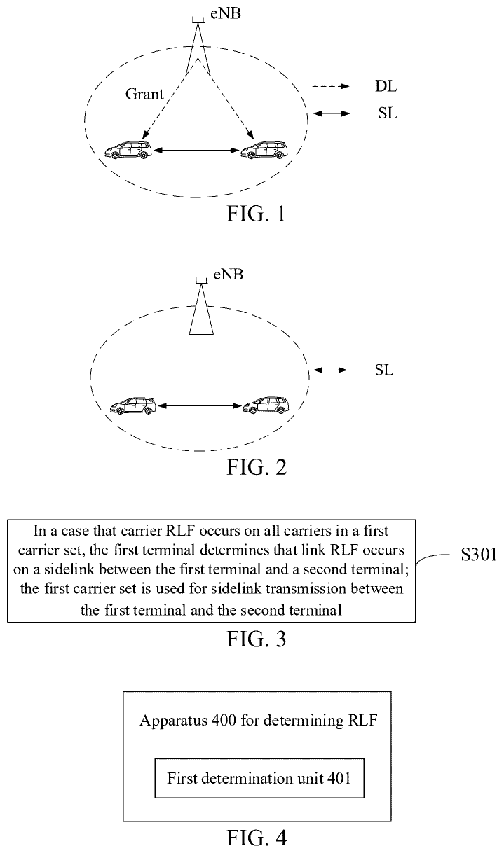

Mode A: Transmission resources for a terminal are allocated by a base station (eNB). The terminal transmits data on the sidelink according to the resources allocated by the base station. The base station may allocate resources for one-time transmission or semi-persistent transmission to the terminal. As shown in FIG. 1, the transmission resources for the terminal are allocated by the base station, which allocates resources to the terminal with grant signaling through the downlink. The terminal performs data transmission on the sidelink using the resources allocated by the base station.

Mode B: The terminal selects a resource from a resource pool for data transmission. As shown in FIG. 2, the terminal may select a resource from the resource pool for data transmission.

In 3GPP, D2D research is carried out in the following phases:
1) Proximity based Service (ProSe): In Rel-12/13, device-to-device communication was studied for ProSe scenarios, mainly targeting public safety services.

In ProSe, by configuring the time-domain position of the resource pool (which, e.g., is discontinuous in the time domain), the UE can transmit/receive data discontinuously on the sidelink, thereby achieving power-saving effects.
2) V2X: In Rel-14/15, the V2X system was studied for vehicle-to-vehicle communication scenarios, mainly focusing on high-speed mobile vehicle-to-vehicle and vehicle-to-person communication services.

In V2X, since vehicle-mounted systems have continuous power supply, power efficiency is not a major concern, while data transmission latency is critical. Therefore, the system design requires terminal devices to transmit and receive data continuously.
3) Wearable Devices (FeD2D): In Rel-14, in this scenario, study is focused on wearable devices accessing the network through mobile phones, mainly targeting low-mobility and low-power access scenarios.

In FeD2D, during the pre-research phase, 3GPP concluded that the base station can configure Discontinuous Reception (DRX) parameters for a remote terminal through a relay terminal, but no specific details on how to configure DRX were provided.

### 2. NR V2X

Building on LTE V2X, NR V2X expands beyond broadcast scenarios to unicast and multicast scenarios, where V2X applications are studied.

Similar to LTE V2X, NR V2X also defines two resource grant modes: mode-1/2 (i.e., the aforementioned Mode A and Mode B). In some scenarios, a user may operate in a hybrid mode, i.e., the user can obtain resources using both mode-1 (Mode A) and mode-2 (Mode B). Resource acquisition is indicated via sidelink grant, i.e., the sidelink grant indicates the time-frequency positions of the corresponding Physical Sidelink Control Channel (PSCCH) and Physical Sidelink Shared Channel (PSSCH) resources.

Different from LTE V2X, NR V2X introduces feedback-based Hybrid Automatic Repeat reQuest (HARQ) retransmission in addition to the feedback-free HARQ retransmission independently initiated by the UE. This applies not only to unicast communication but also to multicast communication.

### 3. LTE-V2X Carrier Aggregation (CA)

Carrier selection in LTE-V2X carrier aggregation is implemented through the following mechanism:

The upper layer configures the mapping relationship between service types and carriers. Specifically, for a specific service, the upper layer indicates the available carrier(s) to the Access Stratum (AS);

Furthermore, the AS layer configures the available carrier set for each logical channel and the Channel Busy Ratio (CBR) measurement threshold corresponding to data priority in each resource pool. The UE measures the CBR value in the resource pool and compares it with the CBR threshold corresponding to the priority of the data to be transmitted. If the measured value is lower than the threshold, the carrier is considered available.

### 4. NR Uu Carrier Aggregation (CA)

CA is a bandwidth expansion technology supported since the LTE-Advanced standard. It aggregates multiple Component Carriers (CCs), which are received or transmitted by a UE simultaneously. Based on the range of aggregated carriers, CA is divided into Intra-band CA and Inter-band CA. One main application of intra-band CA is in scenarios where the cell carrier bandwidth exceeds the single-carrier bandwidth capability of the UE. In such cases, the UE can use CA to operate in a “wide carrier”. For example, if the base station supports a 300 MHz carrier while the UE only supports a maximum of a 100 MHz carrier, the UE can use CA to achieve broadband operation of over 100 MHz. The aggregated carriers can be either adjacent carriers or non-adjacent carriers.

### Cross-Carrier Scheduling

Cross-carrier scheduling with a Carrier Indicator Field (CIF) allows the Physical Downlink Control Channel (PDCCH) of one serving cell to schedule resources of another serving cell, but it has the following limitations:
1) The Primary Cell (PCell) cannot use cross-carrier scheduling, i.e., the PCell is always scheduled via its own PDCCH;
2) If a Secondary Cell (SCell) is configured with a PDCCH, the Physical Downlink Shared Channel (PDSCH) and Physical Uplink Shared Channel (PUSCH) of the cell are always scheduled via the PDCCH of the SCell;
3) If an SCell is not configured with a PDCCH, the PDSCH and PUSCH of the SCell are always scheduled via the PDCCH of another serving cell.

It should be noted that the scheduling PDCCH and the scheduled PDSCH/PUSCH can use the same or different Sub-Carrier Spaces (SCSs). Before R16, cross-carrier scheduling only supported the same SCS for the scheduling PDCCH and the scheduled PDSCH/PUSCH. Starting from R16, both same and different SCS configurations are supported.

The above is a brief description of the related technologies/terms involved in the embodiments of the present disclosure, which will not be repeated in the subsequent embodiments.

It should be understood that the terms “system” and “network” are often used interchangeably herein. The term “and/or” herein merely describes an associative relationship between associated objects, indicating three possible relationships. For example, A and/or B may mean: A exists alone, A and B exist simultaneously, or B exists alone. In addition, the character “/” herein generally indicates that the associated objects before and after are in an “or” relationship. It should also be understood that “indication” mentioned in the embodiments of the present disclosure may be direct indication, indirect indication, or indication of an associative relationship. For example, A indicating B may mean that A directly indicates B (e.g., B can be obtained through A), A indirectly indicates B (e.g., A indicates C, and B can be obtained through C), or there is an associative relationship between A and B. It should also be understood that “correspondence” mentioned in the embodiments of the present disclosure may mean direct correspondence, indirect correspondence, or an associative relationship between the two, and may also refer to relationships such as indicating and being indicated, configuring and being configured, etc. It should also be understood that “predefined” or “predefined rule” mentioned in the embodiments of the present disclosure can be implemented by pre-storing corresponding codes, tables, or other means capable of indicating relevant information in a device (including terminal device and network device), and the specific implementation manner is not limited in the present disclosure.

It should also be understood that the present disclosure does not limit the specific form of the terminal in the embodiments. For example, the terminal in the embodiments of the present disclosure may refer to an access terminal, User Equipment (UE), user unit, user station, mobile station, remote station, remote terminal, mobile device, user terminal, terminal, wireless communication device, user agent, or user device. The access terminal may be a cellular phone, cordless phone, Session Initiation Protocol (SIP) phone, IoT device, satellite handheld terminal, Wireless Local Loop (WLL) station, Personal Digital Assistant (PDA), handheld device with wireless communication function, computing device or other processing device connected to a wireless modem, in-vehicle device, wearable device, terminal device in a 5G network, or terminal device in a future evolved network, etc.

In the existing NR SL system, a single-carrier-based RLF mechanism is designed. In a single-carrier system, if a transmitting terminal (sender) fails to receive the PSFCH sent by a receiving terminal (receiver) at the PSFCH reception timing (i.e., the transmitting terminal does not receive the HARQ feedback information sent by the receiving terminal), and the number of times for which such event occurs reaches a certain number, RLF is triggered.

For example, HARQ feedback information is carried at the PSFCH reception timing associated with the PSSCH. In one possible case, if the transmitting terminal does not receive the PSFCH at the PSFCH reception timing, the value of numConsecutiveDTX is incremented by 1. When the value of numConsecutiveDTX reaches sl-maxNumConsecutiveDTX, RLF is triggered. In another possible case, if the transmitting terminal receives the PSFCH at the PSFCH reception timing, the value of numConsecutiveDTX is reinitialized to 0.

However, at present, there is no solution about how to determine whether RLF occurs on a sidelink in a multi-carrier system.

In view of this, the present disclosure provides a method and apparatus for determining radio link failure, a terminal, a chip, and a storage medium. The method may be executed by a terminal (e.g., the first terminal) or by a chip, a chip system, or a circuit configured in the terminal, which is not limited in the embodiments of the present disclosure. For the convenience of description, the following description takes the method executed by the first terminal as an example.

In this method, if carrier RLF occurs on all carriers in the first carrier set, it can be determined that link RLF occurs on the sidelink between the first terminal and the second terminal. Here, the first carrier set is used for sidelink transmission between the first terminal and the second terminal. This method solves the problem of how to determine whether RLF occurs on a sidelink in a multi-carrier system.

To facilitate understanding of the technical solutions of the embodiments of the present disclosure, the technical solutions of the present disclosure are described in detail below through specific embodiments. The above-related technologies can be combined with the technical solutions of the embodiments of the present disclosure in any way, and all such combinations fall within the protection scope of the embodiments of the present disclosure. The embodiments of the present disclosure include at least part of the following content.

Embodiments of the present disclosure provide a method and apparatus for determining radio link failure, a terminal, a chip, and a storage medium.

According to a first aspect, an embodiment of the present disclosure provides a method for determining radio link failure, applied to a first terminal. The method includes: in a case that carrier radio link failure (RLF) occurs on all carriers in a first carrier set, determining that link RLF occurs on the sidelink between the first terminal and a second terminal. Here, the first carrier set is used for sidelink transmission between the first terminal and the second terminal.

According to a second aspect, an embodiment of the present disclosure provides an apparatus for determining radio link failure. The apparatus includes: a first determination unit, configured to determine that link RLF occurs on the sidelink between the apparatus and a second terminal, in a case that carrier radio link failure (RLF) occurs on all carriers in a first carrier set. Here, the first carrier set is used for sidelink transmission between the apparatus and the second terminal.

According to a third aspect, an embodiment of the present disclosure provides a terminal, including a processor and a memory. The memory is configured to store a computer program, and the processor is configured to call and execute the computer program stored in the memory to perform the aforementioned method for determining radio link failure.

According to a fourth aspect, an embodiment of the present disclosure provides a chip, configured to implement the aforementioned method for determining radio link failure. Specifically, the chip includes: a processor, configured to call and execute a computer program from a memory, so that a device installed with the chip performs the aforementioned method for determining radio link failure.

According to a fifth aspect, an embodiment of the present disclosure provides a computer-readable storage medium, configured to store a computer program that enables a computer to perform the aforementioned method for determining radio link failure.

According to a sixth aspect, an embodiment of the present disclosure provides a computer program product, including computer program instructions that enable a computer to perform the aforementioned method for determining radio link failure.

According to a seventh aspect, an embodiment of the present disclosure provides a computer program, which, when run on a computer, enables the computer to perform the aforementioned method for determining radio link failure.

The above technical solution solves the problem of how to determine whether RLF occurs on a sidelink in a multi-carrier system.

FIG. 3 is a schematic flowchart of a method for determining radio link failure according to an embodiment of the present disclosure. As shown in FIG. 3, the method for determining radio link failure may include the following operations.

At S301, in a case that carrier RLF occurs on all carriers in the first carrier set, the first terminal determines that link RLF occurs on the sidelink between the first terminal and the second terminal. Here, the first carrier set is used for sidelink transmission between the first terminal and the second terminal.

As an example, the first carrier set may be configured/defined in any one of the following Manner 1 to Manner 4:

Manner 1: Pre-configuration or Network Configuration

In this manner, the first carrier set may be preconfigured or configured by the network. The manner of network configuration may include, for example, configuration via system messages or dedicated signaling. For example, during the configuration of the first carrier set, the network may configure an appropriate carrier set (i.e., the first carrier set) for sidelink transmission between the first terminal and the second terminal based on factors such as service traffic volume.

Manner 2: Configuration by the First Terminal or the Second Terminal

In this manner, the first carrier set may be configured by the first terminal or the second terminal.

As an implementation manner, the first carrier set is configured by the first terminal. In this case, the first terminal may send fourth indication information to the second terminal, where the fourth indication information is used to indicate the first carrier set. That is, after configuring the first carrier set, the first terminal may notify/configure the first carrier set to the second terminal. Therefore, the first carrier set can also be understood as a carrier set configured by the first terminal for the opposite terminal (the second terminal).

As another implementation manner, the first carrier set is configured by the second terminal. In this case, the second terminal may send fifth indication information to the first terminal, where the fifth indication information is used to indicate the first carrier set. That is, after configuring the first carrier set, the second terminal may notify/configure the first carrier set to the first terminal. Therefore, the first carrier set can also be understood as a carrier set configured by the opposite terminal (the second terminal) for the first terminal.

Taking the first carrier set configured by the first terminal as an example, during the process of configuring the first carrier set, the first terminal may determine the first carrier set based on the capability of the second terminal. For example, if the second terminal only supports simultaneous reception of data on two carriers, the first terminal may define two of the carriers in the multi-carrier system as the carriers in the first carrier set.

Manner 3: The first carrier set is a carrier set determined by the first terminal for data transmission. That is, the first carrier set may be a carrier set selected by the first terminal itself for data transmission.

Manner 4: The first carrier set is a carrier set corresponding to the time-frequency resources (resource grant) used by the first terminal for data transmission

The carrier set corresponding to the time-frequency resources used by the first terminal for data transmission can also be understood as the carrier set corresponding to the time-frequency resources actually used by the first terminal when sending data to the second terminal, or the carrier set corresponding to the time-frequency resources available for the first terminal to perform data transmission.

It should be noted that the first carrier set in the embodiments of the present disclosure can also be understood as a “carrier set of concern”. Since in a multi-carrier system, occurrence of carrier RLF on only one carrier cannot trigger link RLF, the embodiments of the present disclosure configure/define a carrier set of concern (the first carrier set) for the multi-carrier system, and determine that link RLF occurs on the sidelink (or link RLF is triggered) only when carrier RLF occurs on all carriers in this carrier set of concern. This clarifies which carriers need to be concerned when triggering link RLF in a multi-carrier system, thereby solving the problem of how to determine whether RLF occurs on a sidelink in a multi-carrier system.

In some embodiments, the occurrence of carrier RLF on any carrier in the first carrier set is determined based on the value of the counter (numConsecutiveDTX) corresponding to the carrier reaching a first threshold (sl-maxNumConsecutiveDTX). For the first terminal, if PSFCH is not received on the carrier at the PSFCH reception timing, the value of the counter corresponding to the carrier is incremented by 1. Correspondingly, if the first terminal receives the PSFCH on the carrier at the PSFCH reception timing, the value of the counter corresponding to the carrier is initialized to 0.

For example, assuming the first carrier set includes Carrier #1, if the first terminal does not receive the PSFCH on Carrier #1 at the PSFCH reception timing, the value of the counter corresponding to Carrier #1 is incremented by 1. When the value of the counter corresponding to Carrier #1 reaches the first threshold, it can be determined that carrier RLF occurs on Carrier #1. The first threshold may be preconfigured or configured by the network. Correspondingly, if the first terminal receives the PSFCH on Carrier #1 at the PSFCH reception timing, the value of the counter corresponding to Carrier #1 is initialized to 0.

It should be understood that “carrier RLF occurs on a certain carrier” mentioned in the embodiments of the present disclosure can also be understood as “carrier RLF is triggered on the carrier” or “a carrier RLF state is triggered on the carrier”.

Exemplarily, after determining the first carrier set, it can be determined that link RLF occurs on the sidelink between the first terminal and the second terminal through the following Scheme 1 or Scheme 2.

### Scheme 1

In Scheme 1, when carrier RLF occurs on all carriers in the first carrier set, the Media Access Control (MAC) layer of the first terminal may send first indication information to the Radio Resource Control (RRC) layer, where the first indication information is used to indicate that carrier RLF occurs on all carriers in the first carrier set have. In other words, when carrier RLF occurs on all carriers in the first carrier set, the first terminal may trigger the MAC layer to send an RLF report to the RRC layer, to report that carrier RLF occurs on all carriers in the first carrier set.

The scenario where carrier RLF occurs on all carriers in the first carrier set can also be understood as all carriers in the first carrier set being in a carrier RLF state.

That is, when carrier RLF occurs on a certain carrier in the first carrier set, the MAC layer of the first terminal does not need to send the first indication information to the RRC layer. Only when carrier RLF occurs on all carriers in the first carrier set (e.g., all carriers in the first carrier set are in a carrier RLF state), the MAC layer of the first terminal sends the first indication information to the RRC layer, to indicate that carrier RLF occurs on all carriers in the first carrier set currently.

As an implementation manner, the scenario where carrier RLF occurs on all carriers in the first carrier set may include: when carrier RLF occurs on one of the carriers in the first carrier set, all other carriers in the first carrier set are already in a carrier RLF state. That is, when carrier RLF occurs on one of the carriers in the first carrier set, if all other carriers in the first carrier set are already in a carrier RLF state, it can be considered that carrier RLF occurs on all carriers in the first carrier set, and then the MAC layer of the first terminal sends the first indication information to the RRC layer.

For example, assuming the first carrier set includes the first carrier, when the value of the counter corresponding to the first carrier reaches the first threshold, if the values of the counters corresponding to other carriers in the first carrier set have not reached the first threshold, there is no need to send the first indication information to the RRC layer (i.e., the RLF report to the RRC layer is not triggered); otherwise, the first indication information is sent to the RRC layer (i.e., the RLF report to the RRC layer is triggered).

In Scheme 1, the operation of determining that link RLF occurs on the sidelink between the first terminal and the second terminal in the case that carrier RLF occurs on all carriers in the first carrier set may include: in the case that the RRC layer receives the first indication information, determining that link RLF occurs on the sidelink between the first terminal and the second terminal.

It can be understood that when the RRC layer receives the first indication information, it indicates that carrier RLF occurs on all carriers in the first carrier set. Therefore, in this case, it can be determined that link RLF occurs on the sidelink between the first terminal and the second terminal.

### Scheme 2

In Scheme 2, for any carrier in the first carrier set, in a case that carrier RLF occurs on the carrier, the MAC layer of the first terminal may send second indication information corresponding to the carrier to the RRC layer, where the second indication information is used to indicate that carrier RLF occurs on the carrier. In other words, for any carrier in the first carrier set, in a case that carrier RLF occurs on the carrier, the first terminal may trigger the MAC layer to send an RLF report to the RRC layer to report that carrier RLF occurs on the carrier.

That is, when carrier RLF occurs on a certain carrier in the first carrier set, the MAC layer of the first terminal may send the second indication information corresponding to the carrier to the RRC layer, to indicate that carrier RLF occurs on the carrier.

For example, assuming the first carrier set includes the first carrier, when the value of the counter corresponding to the first carrier reaches the first threshold, the MAC layer of the first terminal may send the second indication information corresponding to the first carrier to the RRC layer (i.e., triggers the RLF report to the RRC layer).

In Scheme 2, the operation of determining that link RLF occurs on the sidelink between the first terminal and the second terminal in the case that carrier RLF occurs on all carriers in the first carrier set may include: in a case that the RRC layer receives the second indication information corresponding to each carrier in the first carrier set, determining that link RLF occurs on the sidelink between the first terminal and the second terminal.

It can be understood that when the RRC layer receives the second indication information corresponding to each carrier in the first carrier set, it indicates that carrier RLF occurs on each carrier in the first carrier set. Therefore, in this case, it can be determined that link RLF occurs on the sidelink between the first terminal and the second terminal.

It should be noted that the time at which carrier RLF occurs on each carrier in the first carrier set may be the same or different, and thus the time at which the RRC layer receives the second indication information corresponding to each carrier may also be the same or different.

In some embodiments, the operation of determining that link RLF occurs on the sidelink between the first terminal and the second terminal in the case that the RRC layer receives the second indication information corresponding to each carrier in the first carrier set may include: in a case that the RRC layer receives the second indication information corresponding to each carrier in the first carrier set and the carrier RLF state of each carrier is not released, determining that link RLF occurs on the sidelink between the first terminal and the second terminal.

Considering that after carrier RLF occurs on a carrier (or a carrier RLF state is triggered), the carrier may return to normal (or the carrier RLF state may be released) within a certain period of time. Therefore, after the RRC layer receives the second indication information corresponding to each carrier in the first carrier set, it also needs to meet a condition that the carrier RLF state of each carrier is not released, so that it can be determined that link RLF occurs on the sidelink between the first terminal and the second terminal.

As an implementation manner, the operation of determining that link RLF occurs on the sidelink between the first terminal and the second terminal in the case that carrier RLF occurs on all carriers in the first carrier set may include: in a case that the RRC layer receives the second indication information corresponding to the first carrier in the first carrier set and the carrier RLF states of other carriers have been triggered and are not released, determining that link RLF occurs on the sidelink between the first terminal and the second terminal.

It can be understood that when the RRC layer receives the second indication information corresponding to the first carrier in the first carrier set, it indicates that carrier RLF occurs on the first carrier (or the carrier RLF state is triggered on the first carrier). In this case, if the carrier RLF states of other carriers in the first carrier set are also triggered, it indicates that carrier RLF occurs on all carriers in the first carrier set. Therefore, in this case, it can be determined that link RLF occurs on the sidelink between the first terminal and the second terminal.

In some embodiments, the method may further include: for any carrier in the first carrier set, in a case that the carrier meets a first condition, the MAC layer of the first terminal sends third indication information corresponding to the carrier to the RRC layer, where the third indication information is used to indicate that the carrier RLF state of the carrier is released.

In the embodiments of the present disclosure, “the carrier RLF state of a certain carrier is released” can also be understood as “the first terminal triggers the MAC layer to send an RLF release report to the RRC layer” or “cancels the previously reported RLF report to the RRC layer”, i.e., cancels the content indicated by the second indication information corresponding to the carrier.

Exemplarily, the aforementioned first condition may include the following Condition A and/or Condition B:

Condition A: The PSFCH is received on the carrier at the PSFCH reception timing.

It can be understood that if the first terminal receives the PSFCH from the second terminal on a certain carrier at the PSFCH reception timing, it indicates that the communication state on the carrier is normal. Therefore, in this case, the MAC layer of the first terminal may send the third indication information corresponding to the carrier to the RRC layer.

For example, if the first terminal receives the PSFCH from the second terminal on the first carrier in the first carrier set at the PSFCH reception timing (meeting Condition A), it indicates that the communication state on the first carrier is normal. Therefore, at this time, the MAC layer of the first terminal may send the third indication information corresponding to the first carrier to the RRC layer. The third indication information corresponding to the first carrier may be sent after carrier RLF occurs on the first carrier.

Condition B: The timer corresponding to the carrier expires.

The timer corresponding to the carrier may be started, for example, when carrier RLF occurs on the carrier, or when the MAC layer of the first terminal sends the second indication information corresponding to the carrier to the RRC layer, or when the RRC layer of the first terminal receives the second indication information corresponding to the carrier.

The timing duration of the timer corresponding to the carrier may be preconfigured or configured by the network. The timing duration may be a configured fixed value or a dynamically configured value, which is not limited in the embodiments of the present disclosure.

It can be understood that if the timer corresponding to a certain carrier in the first carrier set expires, it indicates that the carrier may have recovered from the carrier RLF state. Therefore, in this case, the MAC layer of the first terminal may send the third indication information corresponding to the carrier to the RRC layer.

For example, if the timer corresponding to the first carrier in the first carrier set expires (meeting Condition B), it indicates that the first carrier may have recovered from the carrier RLF state. Therefore, at this time, the MAC layer of the first terminal may send the third indication information corresponding to the first carrier to the RRC layer.

In some embodiments, for any carrier in the first carrier set, after carrier RLF occurs on the carrier (i.e., after the MAC layer of the first terminal sends the second indication information corresponding to the carrier to the RRC layer), in a case that the carrier meets the aforementioned first condition, the third indication information corresponding to the carrier may be sent by the MAC layer of the first terminal to the RRC layer. For example, after carrier RLF occurs on the first carrier in the first carrier set, if the first carrier meets the aforementioned first condition at a certain moment, the MAC layer of the first terminal may send the third indication information corresponding to the first carrier to the RRC layer. In this way, the RRC layer can learn that the first carrier has recovered from the carrier RLF state by receiving the third indication information corresponding to the first carrier.

To facilitate understanding, Scheme 2 is illustrated below through two examples.

### Example 1

Assuming the first carrier set includes the first carrier, when the value of the counter corresponding to the first carrier reaches the aforementioned first threshold, the MAC layer of the first terminal may send the second indication information corresponding to the first carrier to the RRC layer (or trigger an RLF report to the RRC layer), to indicate that carrier RLF occurs on the first carrier. Correspondingly, when the value of the counter corresponding to the first carrier is reinitialized to 0 (for example, the PSFCH is received on the first carrier at the PSFCH reception timing, such that the value of the counter corresponding to the first carrier is initialized to 0), the MAC layer of the first terminal may send the third indication information corresponding to the first carrier to the RRC layer (or trigger an RLF release report to the RRC layer), to indicate that the carrier RLF state of the first carrier is released.

In some scenarios, the event that the value of the counter corresponding to the first carrier is reinitialized to 0 may occur after the value of the counter corresponding to the first carrier reaches the first threshold. Therefore, the event that the MAC layer of the first terminal sends the third indication information corresponding to the first carrier to the RRC layer may occur after carrier RLF occurs on the first carrier.

In Example 1, when the RRC layer receives the second indication information corresponding to the first carrier (or receives the RLF report from the first carrier), if other carriers in the first carrier set have also reported RLF and the RLF report has not been canceled (or the RLF release report has not been triggered), it can be determined that link RLF occurs on the sidelink between the first terminal and the second terminal (i.e., RLF of the sidelink is triggered).

### Example 2

Assuming the first carrier set includes the first carrier, when the value of the counter corresponding to the first carrier reaches the aforementioned first threshold, the MAC layer of the first terminal may send the second indication information corresponding to the first carrier to the RRC layer (or trigger an RLF report to the RRC layer), to indicate that carrier RLF occurs on the first carrier.

When the RRC layer receives the second indication information corresponding to the first carrier (or receives the RLF report from the first carrier), it may start a timer corresponding to the first carrier. When the timer corresponding to the first carrier expires, the MAC layer is triggered to send the third indication information corresponding to the first carrier to the RRC layer (or trigger an RLF release report to the RRC layer), to indicate that the carrier RLF state of the first carrier is released.

In Example 2, when the RRC layer receives the RLF report from the first carrier, if other carriers in the first carrier set have also reported RLF and the RLF report has not been canceled (or the RLF release report has not been triggered), it can be determined that link RLF occurs on the sidelink between the first terminal and the second terminal (i.e., RLF of the sidelink is triggered).

According to the method of the embodiments of the present disclosure, if carrier RLF occurs on all carriers in the first carrier set, the first terminal can determine that link RLF occurs on the sidelink between the first terminal and the second terminal, thereby clarifying the method for determining whether RLF occurs on a sidelink in a multi-carrier system.

The preferred embodiments of the present disclosure have been described in detail above with reference to the accompanying drawings. However, the present disclosure is not limited to the specific details of the above embodiments. Within the scope of the technical concept of the present disclosure, various simple modifications can be made to the technical solutions of the present disclosure, and these simple modifications all fall within the protection scope of the present disclosure. For example, the specific technical features described in the above specific embodiments can be combined in any appropriate way without contradiction. To avoid unnecessary repetition, the present disclosure will not further describe various possible combinations. For another example, various different embodiments of the present disclosure can also be combined arbitrarily, as long as they do not violate the idea of the present disclosure, and they should also be regarded as the content disclosed in the present disclosure. For another example, the various embodiments described in the present disclosure and/or the technical features in the various embodiments can be combined with existing technologies arbitrarily without conflict, and the resulting technical solutions should also fall within the protection scope of the present disclosure.

It should also be understood that in various method embodiments of the present disclosure, the size of the sequence number of the above-described processes does not mean the sequence of execution, and the sequence of execution of each process should be determined by its function and internal logic, and should not constitute any limitation on the implementation of the embodiments of the present disclosure. In addition, in the embodiment of the present disclosure, the terms “downlink”, “uplink”, and “sidelink” are used to indicate the transmission direction of signals or data, wherein “downlink” is used to indicate that the transmission direction of signals or data is a first direction transmitted from the station to the user equipment of the cell, “uplink” is used to indicate that the transmission direction of signals or data is a second direction transmitted from the user equipment of the cell to the station, and “sidelink” is used to indicate that the transmission direction of signals or data is a third direction transmitted from the user equipment 1 to the user equipment 2. For example, “downlink signal” indicates that the transmission direction of the signal is the first direction. In addition, in the embodiment of the present disclosure, the term “and/or” is an association relationship describing an association object, and indicates that there may be three types of relationships. Specifically, A and/or B may represent three cases of A exists alone, both A and B exist, and B exists alone. In addition, the character “/” in this article generally indicates that the related objects before and after are in an “or” relationship.

Based on the aforementioned embodiments, embodiments of the present disclosure provide a corresponding apparatus for determining radio link failure.

FIG. 4 is a schematic diagram of the structural composition of an apparatus for determining radio link failure provided in an embodiment of the present disclosure, which is applied to a first terminal. As shown in FIG. 4, the apparatus 400 for determining radio link failure includes a first determination unit 401.

The first determination unit 401 is configured to configured to determine that link RLF occurs on a sidelink between the apparatus 400 and a second terminal, in a case that carrier RLF occurs on all carriers in a first carrier set. Here, the first carrier set is used for sidelink transmission between the apparatus 400 and the second terminal.

In some embodiments, the apparatus 400 further includes: a first sending unit, configured to enable a Media Access Control (MAC) layer of the apparatus to send first indication information to a Radio Resource Control (RRC) layer, in the case that carrier RLF occurs on all carriers in the first carrier set. Here, the first indication information is used to indicate that carrier RLF occurs on all carriers in the first carrier set.

In some embodiments, the first determination unit 401 is specifically configured to: determine that link RLF occurs between the apparatus 400 and the second terminal, in a case that the RRC layer receives the first indication information.

In some embodiments, the apparatus 400 further includes: a second sending unit, configured to, for any carrier in the first carrier set, in a case that carrier RLF occurs on the carrier, enable the MAC layer of the apparatus 400 to send second indication information corresponding to the carrier to an RRC layer. Here, the second indication information is used to indicate that carrier RLF occurs on the carrier.

In some embodiments, the first determination unit 401 is specifically configured to: determine that link RLF occurs between the apparatus 400 and the second terminal, in a case that the RRC layer receives the second indication information corresponding to each carrier in the first carrier set.

In some embodiments, the first determination unit 401 is specifically configured to determine that link RLF occurs on the sidelink between the apparatus 400 and the second terminal, in a case that the RRC layer receives the second indication information corresponding to each carrier in the first carrier set and the carrier RLF state of each carrier is not released.

In some embodiments, the first determination unit 401 is specifically configured to determine that link RLF occurs on the sidelink between the first terminal and the second terminal, in a case that the RRC layer receives the second indication information corresponding to each carrier in the first carrier set and the carrier RLF states of other carriers have been triggered and are not released.

In some embodiments, the apparatus 400 further includes: a third sending unit, configured to, for any carrier in the first carrier set, in a case that the carrier meets a first condition, enable the MAC layer of the apparatus 400 to send third indication information corresponding to the carrier to the RRC layer. Here, the third indication information is used to indicate that the carrier RLF state of the carrier is released.

In some embodiments, the third indication information corresponding to the carrier is sent by the MAC layer of the apparatus 400 to the RRC layer after carrier RLF occurs on the carrier.

In some embodiments, the first condition includes: a Physical Sidelink Feedback Channel (PSFCH) being received on the carrier at a PSFCH reception timing; and/or, a timer corresponding to the carrier expiring. Here, the timer corresponding to the carrier is started when carrier RLF occurs on the carrier.

In some embodiments, a timing duration of the timer is preconfigured or configured by the network.

In some embodiments, occurrence of carrier RLF on any carrier in the first carrier set is determined based on a value of a counter corresponding to the carrier reaching a first threshold; if no PSFCH is received on the carrier at the PSFCH reception timing, the value of the counter corresponding to the carrier is incremented by 1.

In some embodiments, the apparatus 400 further includes: a second determination unit, configured to determine that carrier RLF occurs on the carrier when the value of the counter corresponding to the carrier reaches the first threshold.

In some embodiments, the first threshold is preconfigured or configured by the network.

In some embodiments, if a PSFCH is received on the carrier at the PSFCH reception timing, the value of the counter corresponding to the carrier is initialized to 0.

In some embodiments, the first carrier set is preconfigured or configured by the network; or, the first carrier set is configured by the apparatus 400 or the second terminal; or, the first carrier set is a carrier set determined by the apparatus 400 for data transmission; or, the first carrier set is a carrier set corresponding to the time-frequency resources used by the apparatus 400 for data transmission.

In some embodiments, the apparatus 400 further includes: a fourth sending unit, configured to send fourth indication information to the second terminal, in a case that the first carrier set is configured by the apparatus 400. Here, the fourth indication information is used to indicate the first carrier set.

Those skilled in the art should understand that the relevant descriptions of the aforementioned apparatus for determining radio link failure in the embodiments of the present disclosure may be understood with reference to the relevant descriptions of the method for determining radio link failure in the embodiments of the present disclosure.

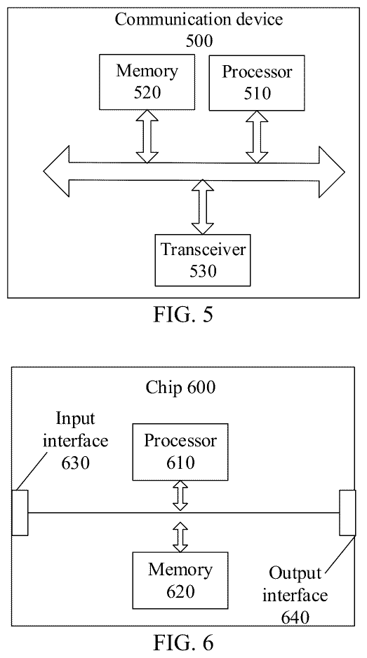

FIG. 5 is a schematic structural diagram of a communication device 500 provided in an embodiment of the present disclosure. The communication device 500 shown in FIG. 5 includes a processor 510, and the processor 510 may call and execute a computer program from a memory to implement the methods in the embodiments of the present disclosure.

Optionally, as shown in FIG. 5, the communication device 500 may further include a memory 520. The processor 510 may call and execute a computer program from the memory 520 to implement the methods in the embodiments of the present disclosure.

The memory 520 may be an independent device separate from the processor 510, or may be integrated into the processor 510.

Optionally, as shown in FIG. 5, the communication device 500 may further include a transceiver 530. The processor 510 may control the transceiver 530 to communicate with other devices; specifically, the processor 510 may send information or data to other devices, or receive information or data sent by other devices.

The transceiver 530 may include a transmitter and a receiver. The transceiver 530 may further include one or more antennas.

The communication device 500 may be specifically a terminal (e.g., the first terminal) in the embodiments of the present disclosure, and the communication device 500 may implement the corresponding processes performed by the terminal (e.g., the first terminal) in each method of the embodiments of the present disclosure. For the sake of brevity, details are not repeated herein.

FIG. 6 is a schematic structural diagram of a chip provided in an embodiment of the present disclosure. The chip 600 shown in FIG. 6 includes a processor 610, and the processor 610 may call and execute a computer program from a memory to implement the methods in the embodiments of the present disclosure.

Optionally, as shown in FIG. 6, the chip 600 may further include a memory 620. The processor 610 may call and execute a computer program from the memory 620 to implement the methods in the embodiments of the present disclosure.

The memory 620 may be an independent device separate from the processor 610, or may be integrated into the processor 610.

Optionally, the chip 600 may further include an input interface 630. The processor 610 may control the input interface 630 to communicate with other devices or chips; specifically, the processor 610 may obtain information or data sent by other devices or chips.

Optionally, the chip 600 may further include an output interface 640. The processor 610 may control the output interface 640 to communicate with other devices or chips; specifically, the processor 610 may output information or data to other devices or chips.

The chip may be applied to a terminal (e.g., the first terminal) in the embodiments of the present disclosure, and the chip may implement the corresponding processes performed by the terminal (e.g., the first terminal) in each method of the embodiments of the present disclosure. For the sake of brevity, details are not repeated herein.

It should be understood that the chip mentioned in the embodiments of the present disclosure may also be referred to as a system-on-chip (SoC), system chip, chip system, or on-chip system chip, etc.

It should be understood that the processor of the embodiment of the present disclosure may be an integrated circuit chip having signal processing capabilities. In the implementation process, the steps of the above-described method embodiments may be completed by integrated logic circuits of hardware in the processor or instructions in the form of software. The processor described above may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the present disclosure may be implemented or executed. The general purpose processor may be a microprocessor or the processor may be any conventional processor or the like. The steps of the method disclosed in connection with the embodiments of the present disclosure may be directly embodied as execution by the hardware decoding processor, or may be executed by combining hardware and software modules in the decoding processor. The software module may be located in a storage medium mature in the art, such as random access memory, flash memory, read-only memory, programmable read-only memory, or electrically erasable and writable programmable memory, registers, etc. The storage medium is located in the memory, and the processor reads the information in the memory, and combines its hardware to complete the steps of the above method.

It is understood that the memory in the embodiments of the present disclosure may be a volatile memory or a non-volatile memory, or may include both volatile and non-volatile memory. The non-volatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), which serves as an external cache. By way of example, but not limitation, many forms of RAM are available, such as Static RAM (SRAM), Dynamic RAM (DRAM), Synchronous DRAM (SDRAM), Double Data Rate SDRAM (DDR SDRAM), Enhanced SDRAM (ESDRAM), Synchlink DRAM (SLDRAM), and Direct Rambus RAM (DR RAM). It should be noted that the memory of the systems and methods described herein is intended to include, but is not limited to, these and any other suitable type of memory.

It should be understood that the above memory is illustrative but not limiting, for example, the memory in the embodiments of the present disclosure may also be a static random access memory (SRAM), a dynamic random access memory (DRAM), a synchronous dynamic random access memory (SDRAM), a double data rate synchronous dynamic random access memory (DDR SDRAM), an enhanced SDRAM (ESDRAM), a synch link dynamic random access memory (SLDRAM), a Direct Rambus RAM (DR RAM), and the like. That is, the memory in the embodiments of the present disclosure is intended to include, but is not limited to, these and any other suitable type of memory.

Embodiments of the present disclosure also provide a computer-readable storage medium for storing a computer program. The computer-readable storage medium can be applied to a terminal (e.g., first terminal) in the embodiment of the present disclosure, and the computer program causes the computer to execute the corresponding processes implemented by the terminal (e.g., first terminal) in each method of the embodiment of the present disclosure, and will not be repeated here for the sake of brevity.

Embodiments of the present disclosure also provide a computer program product including computer program instructions. The computer program product can be applied to a terminal (e.g., first terminal) in the embodiment of the present disclosure, and the computer program instructions cause the computer to execute the corresponding processes implemented by the terminal (e.g., first terminal) in each method of the embodiment of the present disclosure, and will not be repeated here for the sake of brevity.

Embodiments of the present disclosure provide a computer program. The computer program can be applied to a terminal (e.g., first terminal) in the embodiment of the present disclosure, and when the computer program is running on the computer, the computer executes the corresponding processes implemented by the terminal (e.g., first terminal) in each method of the embodiment of the present disclosure, which is not repeated here for the sake of brevity.

Those of ordinary skill in the art will appreciate that the elements and algorithmic steps of the various examples described in connection with the embodiments disclosed herein can be implemented in electronic hardware, or a combination of computer software and electronic hardware. Whether these functions are performed in hardware or software depends on the specific application and design constraints of the technical solution. Those skilled in the art may use different methods for implementing the described functions for each particular application, but such implementations should not be considered beyond the scope of the present disclosure.

Those skilled in the art can clearly understand that for convenience and conciseness of the description, the specific working processes of the systems, devices, and units described above may refer to the corresponding processes in the aforementioned method embodiments, and will not be repeatedly described herein.

In several embodiments provided herein, it should be understood that the disclosed systems, apparatuses, and methods may be implemented in other ways. For example, the device embodiments described above are merely schematic, for example, the division of units is only one logical function division, and there may be other division methods in actual implementation, for example, multiple units or components may be combined or integrated into another system, or some features may be ignored or not implemented. In addition, the coupling or direct coupling or communication connection between each other shown or discussed may be an indirect coupling or communication connection through some interface, device or unit, which may be electrical, mechanical or otherwise.

The units described as separate units may or may not be physically separate, and the units displayed as units may or may not be physical units, that is, they may be located in one place or may be distributed over a plurality of network units. Some or all of the units may be selected according to actual needs to achieve the purpose of the solution of the present embodiment.

In addition, each functional unit in each embodiment of the present disclosure may be integrated in one processing unit, each unit may be physically present alone, or two or more units may be integrated in one unit.

The functions may be stored in a computer-readable storage medium if implemented in the form of software functional units and sold or used as independent products. Based on this understanding, the technical solution of the present disclosure essentially or a part that contributes to the prior art or a part of the technical solution may be embodied in the form of a software product, which is stored in a storage medium and includes several instructions for causing a computer device (which may be a personal computer, a server, or a network device, etc.) to perform all or part of the steps of the method described in various embodiments of the present disclosure. The storage medium includes a USB disk, a removable hard disk, a Read-Only Memory (ROM), a Random Access Memory (RAM), a magnetic disk, or an optical disk that can store a program code.

The above is merely a specific embodiment of the present disclosure, but the scope of protection of the present disclosure is not limited thereto, and any person skilled in the art can easily think of changes or substitutions within the technical scope disclosed in the present disclosure, and should be covered within the scope of protection of the present disclosure. Therefore, the scope of protection of the present disclosure should be subject to the scope of protection of the claims.

1. A method for determining radio link failure (RLF), applied to a first terminal, the method comprising:
in a case that carrier RLF occurs on all carriers in a first carrier set, determining that link RLF occurs on a sidelink between the first terminal and a second terminal; wherein the first carrier set is used for sidelink transmission between the first terminal and the second terminal.

2. The method according to claim 1, wherein in the case that carrier RLF occurs on all carriers in the first carrier set, the method further comprises:
sending, by a Media Access Control (MAC) layer of the first terminal, first indication information to a Radio Resource Control (RRC) layer, wherein the first indication information is used to indicate that carrier RLF occurs on all carriers in the first carrier set.

3. The method according to claim 2, wherein in the case that carrier RLF occurs on all carriers in the first carrier set, determining that link RLF occurs on the sidelink between the first terminal and the second terminal comprises:
in a case that the RRC layer receives the first indication information, determining that link RLF occurs on the sidelink between the first terminal and the second terminal.

4. The method according to claim 1, further comprising:
for any carrier in the first carrier set, in a case that carrier RLF occurs on the carrier, sending, by an MAC layer of the first terminal, second indication information corresponding to the carrier to an RRC layer, wherein the second indication information is used to indicate that carrier RLF occurs on the carrier.

5. The method according to claim 1, wherein occurrence of carrier RLF on any carrier in the first carrier set is determined based on a value of a counter corresponding to the carrier reaching a first threshold; wherein if no PSFCH is received on the carrier at the PSFCH reception timing, the value of the counter corresponding to the carrier is incremented by 1.

6. The method according to claim 5, further comprising:
determining that carrier RLF occurs on the carrier when the value of the counter corresponding to the carrier reaches the first threshold.

7. The method according to claim 1, wherein the first carrier set is a carrier set determined by the first terminal for data transmission.

8. A terminal, comprising: a processor and a memory, the memory is configured to store a computer program, and the processor is configured to call and run the computer program stored in the memory to:
determine that link RLF occurs on a sidelink between the apparatus and a second terminal, in a case that carrier RLF occurs on all carriers in a first carrier set, wherein the first carrier set is used for sidelink transmission between the apparatus and the second terminal.

9. The terminal according to claim 8, wherein the processor is further configured to:
enable a Media Access Control (MAC) layer of the apparatus to send first indication information to a Radio Resource Control (RRC) layer, in the case that carrier RLF occurs on all carriers in the first carrier set, wherein the first indication information is used to indicate that carrier RLF occurs on all carriers in the first carrier set.

10. The terminal according to claim 9, wherein the processor is configured to:
determine that link RLF occurs on the sidelink between the apparatus and the second terminal, in a case that the RRC layer receives the first indication information.

11. The terminal according to claim 8, wherein the processor is further configured to:
for any carrier in the first carrier set, enable the MAC layer of the apparatus to send second indication information corresponding to the carrier to an RRC layer, in a case that carrier RLF occurs on the carrier, wherein the second indication information is used to indicate that carrier RLF occurs on the carrier.

12. The terminal according to claim 8, wherein occurrence of carrier RLF on any carrier in the first carrier set is determined based on a value of a counter corresponding to the carrier reaching a first threshold; wherein if no PSFCH is received on the carrier at the PSFCH reception timing, the value of the counter corresponding to the carrier is incremented by 1.

13. The terminal according to claim 12, wherein the processor is further configured to:
determine that carrier RLF occurs on the carrier when the value of the counter corresponding to the carrier reaches the first threshold.

14. The terminal according to claim 8, wherein the first carrier set is a carrier set determined by the apparatus for data transmission.

15. A chip, comprising: a processor, configured to call and run a computer program from a memory, so that a device installed with the chip executes a method for determining radio link failure (RLF), the method comprising:
in a case that carrier RLF occurs on all carriers in a first carrier set, determining that link RLF occurs on a sidelink between the first terminal and a second terminal; wherein the first carrier set is used for sidelink transmission between the first terminal and the second terminal.

16. The chip according to claim 15, wherein in the case that carrier RLF occurs on all carriers in the first carrier set, the method further comprises:
sending, by a Media Access Control (MAC) layer of the first terminal, first indication information to a Radio Resource Control (RRC) layer, wherein the first indication information is used to indicate that carrier RLF occurs on all carriers in the first carrier set.

17. The chip according to claim 16, wherein in the case that carrier RLF occurs on all carriers in the first carrier set, determining that link RLF occurs on the sidelink between the first terminal and the second terminal comprises:
in a case that the RRC layer receives the first indication information, determining that link RLF occurs on the sidelink between the first terminal and the second terminal.

18. The chip according to claim 15, wherein the method further comprises:
for any carrier in the first carrier set, in a case that carrier RLF occurs on the carrier, sending, by an MAC layer of the first terminal, second indication information corresponding to the carrier to an RRC layer, wherein the second indication information is used to indicate that carrier RLF occurs on the carrier.

19. The chip according to claim 15, wherein occurrence of carrier RLF on any carrier in the first carrier set is determined based on a value of a counter corresponding to the carrier reaching a first threshold; wherein if no PSFCH is received on the carrier at the PSFCH reception timing, the value of the counter corresponding to the carrier is incremented by 1.

20. The chip according to claim 19, wherein the method further comprises:
determining that carrier RLF occurs on the carrier when the value of the counter corresponding to the carrier reaches the first threshold.
